(19) United States
(12) Patent Application Publication
(10) Pub. No.: US 2026/0124672 A1
(43) Pub. Date: May 7, 2026

(54) METHODS FOR CREATING PARTIALLY REUSABLE CASTING MOLDS AND/OR MULTIPLE COPIES OF A PART USING THE SAME, RELATED SYSTEMS, MOLDS, AND PARTS

(71) Applicant: Mark Lamoncha, Columbiana, OH (US)

(72) Inventor: Mark Lamoncha, Columbiana, OH (US)

(21) Appl. No.: 19/380,375

(22) Filed: Nov. 5, 2025

Related U.S. Application Data
(60) Provisional application No. 63/716,999, filed on Nov. 6, 2024.

(51) Int. Cl. B22C 9/10; B22C 9/04; B22C 9/06; B33Y 80/00

(52) U.S. Cl. CPC B22C 9/10; B22C 9/046; B22C 9/06; B33Y 80/00

(57) ABSTRACT

Methods for creating partially reusable casting molds and/or multiple copies of a part using the same, along with related systems, molds, and parts, are disclosed. Reusable outer shells and sacrificial inserts for placement inside the reusable outer shells are generated by way of additive manufacturing. The sacrificial inserts and reusable outer shells are assembled into a mold such that the sacrificial inserts are placed within the reusable outer shells and define an internal cavity for the past to be casted. Casting material is poured into the internal cavity to cast the part such that a portion of the sacrificial inserts are sacrificed. The part is excavated, including removing the reusable outer shells for reuse and remaining portions of the sacrificial inserts for disposal.

### CROSS-REFERENCE TO RELATED APPLICATIONS

This application claims the benefit of U.S. provisional patent application Ser. No. 63/716,999 filed Nov. 6, 2024, the disclosures of which are hereby incorporated by reference as if fully restated herein.

### TECHNICAL FIELD

Exemplary embodiments relate generally to methods for creating partially reusable casting molds, such as comprising sacrificial, 3D-printed inserts and reusable, 3D-printed, high strength outer shells, and/or multiple copies of a part using the same, as well as related systems, molds, and parts.

### BACKGROUND AND SUMMARY OF THE INVENTION

Various forms of casting are known. Investment casting or lost-wax casting is one such known form of casting whereby a wax pattern is coated with a ceramic material, thereby melting the wax. Another type of casting involves 3D printing casting molds, such as by way of binder jetting, where material to be casted is poured into the mold to create the casting. The mold is then sacrificed, typically by breaking it apart and excavating the casted part. The use of additive manufacturing, such as 3D printing, to generate molds has advantages, including the ability to relatively quickly and efficiently create molds for relatively complex parts with relatively close tolerances. Additive manufacturing, such as 3D printing, may be utilized for generating molds to create casted parts that are not otherwise available or practically available for manufacture by way of casting. However, it is undesirable to sacrifice the molds each time, which requires creating molds on a one-to-one basis with the number of parts desired to be casted.

Methods are disclosed for creating casting molds and/or parts using one or more sacrificial, 3D-printed insert(s) and one or more reusable, 3D-printed, high strength outer shell(s) as well as related systems and components. Data for a part to be manufactured by way of casting is collected. In exemplary embodiments, without limitation, the data is gathered through 3D scanning of a sample of the part. Alternatively, or additionally, the data may be provided through one or more drawing files (e.g., 3D part and/or assembly files).

An outer shell may be generated, such as using 3D printing, such as binder jetting, and infiltrated with one or more relatively high strength materials, such as various high strength polymers, such as but not limited to, polyurethane though other materials may be utilized. The outer shell may be printed as one or more parts, such as two parts (e.g., substantial halves) which come together to form the outer shell (sometimes referred to herein as the “shells”or “shell(s)”).

An inner, sacrificial insert may be printed, such as using 3D printing, such as binder jetting. The inner insert may be printed using binder jetting materials, such as non-infiltrated build sand, by way of non-limiting example. The inserts may be provided in multiple parts, such as two parts (e.g., substantial halves). In exemplary embodiments, without limitation, the insert parts (sometimes referred to herein as the “inserts” or “insert(s)”) are provided on a one to one basis with the shell(s). The insert(s) may be configured to fit within the shell(s), such as by friction fit, fasteners, cooperative structural elements (e.g., mating slots and recesses, mating recess and protrusions, interference fit points, combinations thereof, or the like), adhesive, combinations thereof, or the like. Alternatively, or additionally, the insert(s) and/or the shell(s) may be generated with apertures or other spaces for fasteners (e.g., nuts and bolts, clamps) to be received to secure the items to one another. The inserts and/or shells may include such elements for cooperation or securement to one another (e.g., insert to insert, insert to shell).

In exemplary embodiments, without limitation, the data for the shell(s) and/or insert(s) may be automatically generated from the data. For example, without limitation, the insert(s) may be automatically generated based on the 3D scanned data or uploaded drawing data. A predetermined thickness may be added based on a selected or default casting material and known needs for additional, sacrificial material. The outer shell may be automatically defined, at least in part, accordingly so that the insert(s) fit therein. Apertures for casting material may be automatically added along with other known casting features, including but not limited to, mold handles, sprues, runners, ejector pin locations, combinations thereof, or the like.

The mold may be assembled. The casting material may be poured into the mold, such as to reach within the cavity defined by the insert(s). The insert(s) may be at least partially consumed by the casting material when poured. The casting material may be cured, such as by allowing time to pass (e.g., passively) and/or taking active steps such as heating, airflow, combinations thereof, or the like. The outer shell may be removed and any remaining insert material may be removed from the underlying part, such as by excavation tools and/or techniques (e.g., brushing, scraping, air blasting, sand blasting, combinations thereof, or the like). The casted product may be removed for use.

The shell to be reused, such as with new insert(s), to cast additional quantities of the part. This may reduce manufacturing costs, material usage, and/or complexities.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical, similar, or equivalent features, and wherein:

FIG. 1 is a flow chart with an exemplary method for creating casting molds and/or parts;

FIG. 2 is a perspective view of exemplary components of an exemplary casting mold in unassembled form for use with the method of FIG. 1; and

FIG. 3 is a plan view of an exemplary system for use with the method of FIG. 1.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

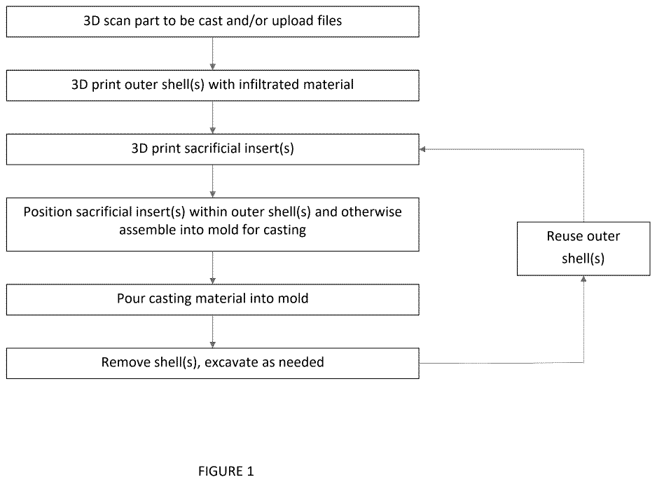

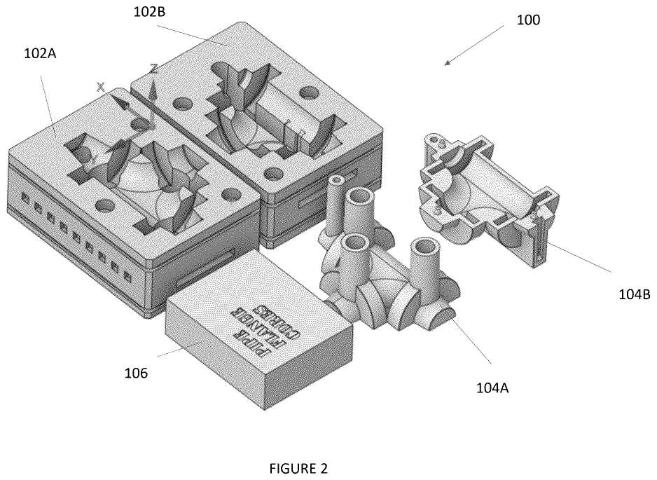

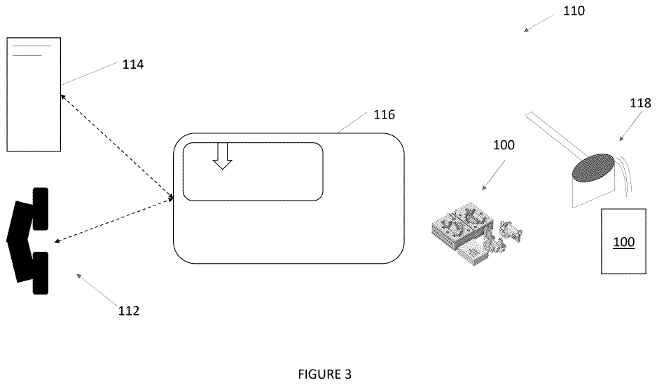

FIG. 1 illustrates an exemplary method for creating casting molds 100 as well as related components thereof and/or casted parts from such molds 100. Exemplary components of such casting molds 100 are illustrated at FIG. 2 in unassembled form. An exemplary system 110 for generating the casting molds 100, including the components thereof, and/or the casted parts using such molds 100, such as by way of the method of FIG. 1 is provided at FIG. 3.

The casting molds 100 may comprise a sacrificial, 3D-printed insert 104 and a reusable, 3D-printed, high strength outer shell 102. In exemplary embodiments, without limitation, the sacrificial insert 104 is provided in at least two parts 104A, 104B and the shell 102 is likewise provided in at least two parts 102A, 102B such that the mold 100 is assembled by fitting each of the inserts 104 within a corresponding one of the shells 102 and bringing the parts together to form a mold 100. The size, shape, number, and/or arrangement of the components (e.g., inserts 104, shells 102) may be varied, particularly to generate various size, shape, number, and/or arrangement of an inner cavity into which material 118 is poured for casting into a part. The casting material 118 may include one or more molten metals (e.g., iron, steel, aluminum, copper, magnesium, zinc, tin, nickel, cobalt, alloys thereof) or one or more polymers and resins (e.g., epoxy, polyurethane, silicone rubber, polyester resins, or the like). As further explained herein, the inserts 104 may be sacrificed while the shell 102 is reused with new inserts to create further quantities of the part. Spaces (e.g., holes, threaded or otherwise) may optionally be provided for fasteners (e.g., nuts and bolts, clamps) to connect the inserts 104 and/or shells 102 to one another.

Data for a part to be cast is collected, such as from 3D scanning of a sample of the part using one or more 3D scanning devices 112 and/or through provision (e.g., upload) of one or more part files from one or more computer systems 114. The data may include spatial data that describes one or more of shape and/or surface geometry, such as point clouds, meshes, texture maps, or reflectivity depth data. Data may be provided in one or more various formats, such as polygon file format (.PLY, though other formats such as .XYZ, .LAS, .FBX may be utilized), wavefront object (.OBJ), steroltihograry (.STL), either natively, or by conversion. Software may be utilized to create, in an at least partially automated fashion, 3D printing data and/or commands for making the inserts 104 and/or shells 102 for the mold for the part, such as those available from AutoDesk and/or AutoCast by way of non-limiting example.

The computer system(s) 114 may comprise one or more computers, laptops, databases, servers, smartphones, combinations thereof, or the like. The computer system(s) 114 may be remote from and/or part of one of more additive manufacturing machines 116 for generating the mold 100 components.

An outer shell 102 may be printed, such as using the additive manufacturing device(s) 116. In exemplary embodiments, without limitation, the additive manufacturing devices 116 comprise one or more 3D printing machines, such as but not necessarily limited to, binder jetting machines. The outer shell 102 may be provided in one or more separate parts 102A, 102B. For example, without limitation, the outer shell 102 may be printed as two parts 102A, 102B which are movable together to form an inner cavity. In exemplary embodiments, without limitation, the part(s) 102A, 102B are provided as at least substantial (e.g., within 90%) halves. The parts 102 may be the same or different from one another, such as to generate symmetrical or asymmetrical parts or as otherwise required or desirable for casting. For example, without limitation, one of the parts 102A, 102B may comprise a hole for receiving the casting material 118, other casting features, handles for moving/manipulating the shell 102, combinations thereof, or the like.

The outer shell(s) 102 may be infiltrated with one or more relatively high strength materials, such as various high strength polymers, such as but not limited to, polyurethane. Other materials may be utilized, such as but not limited to, ceramics (e.g., colloidal silica/silica sol, alumina or ceramic slurries, fused-silica coatings), bronze or copper alloys, epoxy, phenolic, furan resins, Sodium silicate (e.g., hardened with CO₂), combinations thereof, or the like.

A sacrificial insert 104 may be printed, such as using the same or different additive manufacturing devices 116 (e.g., binder jetting printer(s)). The insert 104 may be provided as one or more parts 104A, 104B. For example, without limitation, an insert 104A, 104B may be provided for each shell 102A, 102B. The insert(s) 104 may be printed using binder jetting materials, such as non-infiltrated build sand, by way of non-limiting example. Such build material/sand may include one or more silica, zircon, olivine, chromite, ceramics (e.g., alumina, silica, zircon), combinations thereof, or the like.

The insert(s) 104 may be configured to fit within the outer shells 102, such as by friction fit. Alternatively, or additionally, the inserts 104 may comprise cooperative structural elements (e.g., mating recess and protrusions), mating slots and recesses, interference fit points, combinations thereof, or the like), be connected by fasteners, adhesive, combinations thereof, or the like. The inserts 104 and/or shells 102 may include such elements for cooperation or securement to one another (e.g., insert to insert, insert to shell).

In exemplary embodiments, without limitation, the data for the shell(s) 102 and/or insert(s) 104 may be automatically generated from the data received for the part to be casted. For example, without limitation, the insert(s) 104 may be automatically generated based on the 3D scanned data or uploaded drawing data. The insert(s) 104 may be generated to have an internal cavity, when assembled, which matches or substantially matches (e.g., within 90%) dimensions of the part. The data for the shell(s) 102 and/or insert(s) may automatically be adjusted to have a tolerance (e.g., 2%) to ensure fit and alignment.

A predetermined thickness may be added to the insert 104 based on a selected or default casting material and known needs for additional, sacrificial material. The outer shell 102 may be automatically defined, at least in part, accordingly so that the inserts 104 fit therein. Apertures for casting material may be automatically added along with other known casting features, including but not limited to, mold handles, sprues, runners, ejector pin locations, combinations thereof, or the like. Such analysis may be performed by the computer systems 114, the devices 116, and/or associated computer systems.

In other exemplary embodiments, without limitation, the data provided may be a 3D scan of a sample mold 100 or components thereof, such as but not limited to, an internal cavity, shell(s) 102, and/or insert(s) 104 and/or one or more files providing the same (e.g., 3D drawing, part, and/or assembly files).

The mold 100 may be assembled. In exemplary embodiments, without limitation, each of the inserts 104 may be placed within one of the shells 102. And the parts (i.e., shells 102 with inserts 104 therein) may be assembled to create the mold 100. Optionally, fasteners (e.g., nuts and bolts, clamps) may be employed to secure the inserts 104 and/or shells 102 to one another.

The casting material 118 may be poured into the mold 100, once assembled, such as to reach a cavity within the insert(s) 104. The insert(s) 104 may be at least partially consumed by the casting material. The outer shell 102 may be removed and any remaining insert 104 may be removed, such as by excavation of the casted part. The casted product may be removed and/or cleaned for use.

The shell(s) 102 may be reused, such as with new and/or other of the insert(s) 104.

Additional parts 106 may be printed as needed for the mold 100 and/or to support the casting and/or excavation process. These parts 106 may be printed independently or within a box or other object with loose sand therein, by way of non-limiting example.

Reusable, as used herein, may refer to an ability to reuse multiple times (e.g., twice, ten times, 100 times, etc.) under intended use conditions, such as shown and described herein, but does not necessarily mean infinitely reusable, particularly under non-standard conditions. For example, the outer shells 102 described herein may eventually crack or otherwise become unsuitable after many uses.

Sacrificial, as used herein, may refer to being at least partially consumed or otherwise rendered unusable under intended use conditions, such as shown and described herein, but does not necessarily mean fully consumed or otherwise rendered unusable. For example, the sacrificial inserts 104 described herein may be partially, but not wholly, consumed during casting.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention.

Certain operations described herein may be performed by one or more electronic devices. Each electronic device may comprise one or more processors, electronic storage devices, executable software instructions, combinations thereof, and the like configured to perform the operations described herein. The features and/or functionality shown and/or described herein may be accomplished by way of stored, executable software instructions, such as in the form of applications, programs, routines, combinations thereof, or the like. The electronic devices may be general purpose computers or specialized computing devices. The electronic devices may comprise personal computers, smartphones, tablets, databases, servers, or the like. The electronic connections and transmissions described herein may be accomplished by one or more wired or wireless connectivity components (e.g., routers, modems, ethernet cables, fiber optic cable, telephone cables, signal repeaters, and the like) and/or networks (e.g., internets, intranets, cellular networks, the world wide web, local area networks, and the like). The computerized hardware, software, components, systems, steps, methods, and/or processes described herein may serve to improve the speed of the computerized hardware, software, systems, steps, methods, and/or processes described herein. The electronic devices, including but not necessarily limited to the electronic storage devices, databases, controllers, or the like, may comprise and/or be configured to hold, solely non-transitory signals.

What is claimed is:

1. A method for casting multiple copies of a part using a partially reusable casting mold, said method comprising:
generating, by way of additive manufacturing, reusable outer shells;
generating, by way of additive manufacturing, sacrificial inserts for placement inside the reusable outer shells, the sacrificial inserts, when assembled, defining an internal cavity for the part to be casted;
assembling the sacrificial inserts and reusable outer shells into a mold such that the sacrificial inserts are placed within the reusable outer shells and define the internal cavity;
pouring casting material into the internal cavity to cast the part such that a portion of the sacrificial inserts are sacrificed; and
excavating the part, including removing the reusable outer shells for reuse and remaining portions of the sacrificial inserts for disposal.

2. The method of claim 1 wherein:
the sacrificial inserts are generated using binder jetting; and
the reusable outer shells are generated using binder jetting and infiltrating the build material with a relatively high strength material.

3. The method of claim 2 wherein:
the relatively high strength material comprises a polymer.

4. The method of claim 3 wherein:
the polymer comprises polyurethane.

5. The method of claim 2 wherein:
the sacrificial inserts are generated using non-infiltrated build sand.

6. The method of claim 1 wherein:
the sacrificial inserts and the reusable outer shells, when assembled into the mold, include a hole extending from an outer surface of the mold to the inner cavity for receiving the casting material.

7. The method of claim 6 wherein:
the sacrificial inserts and the reusable outer shells, when assembled into the mold, include one or more apertures for fasteners for securing the sacrificial inserts and the reusable outer shells together; and
the sacrificial inserts and the reusable outer shells include cooperative structural elements for frictional engagement when assembled into the mold.

8. The method of claim 1 further comprising:
receiving data, at a computer system in electronic connection with a 3D printer, for the part; and
generating, in an at least partially automated fashion using the computer system, commands for the 3D printer to generate the sacrificial inserts and the outer molds based, at least in part, on the received data.

9. The method of claim 8 further comprising:
scanning, using a 3D scanning tool, a copy of the part, wherein the data received at the computer system includes spatial data describing the part.

10. The method of claim 8 further comprising:
uploading, to the computer system, one or more drawing files for the part, wherein the data received at the computer system includes one or more drawing files for the part.

11. The method of claim 1 wherein:
the sacrificial inserts and the reusable outer shells, when assembled into the mold, include one or more casting features, selected from the group consisting of: mold handles, sprues, runners, and ejector pin locations.

12. A casted part created using the method of claim 1.

13. The method of claim 1 further comprising:
generating, by way of additive manufacturing, additional copies of the sacrificial inserts (“new inserts”) for making a second copy of the part (“second part”);
assembling the new sacrificial inserts into the reusable outer shells to generate a new mold having a new internal cavity such that the reusable outer shells are reused with the new sacrificial inserts;
pouring additional casting material into the new internal cavity of the new mold to cast the second part such that a portion of the new sacrificial inserts are sacrificed; and
excavating the second part, including by removing the reusable outer shells and remaining portions of the new sacrificial inserts.

14. Multiple copies of a part casted using the method of claim 13.

15. A method for generating a partially reusable casting mold for castings multiple
copies of a part, said method comprising:
generating, by way of binder jetting and infiltration of build sand with a relatively high strength material, reusable outer shells; and
generating, by way of binder jetting of build sand without infiltration, a plurality of sets of sacrificial inserts, wherein each set of the sacrificial inserts is configured for assembly, one set at a time, within the outer shells to define an internal cavity within the respective set of sacrificial inserts for the part to be casted.

16. A partially reusable casting mold generated by the method of claim 15.

17. A method for casting multiple copies of a part using a partially reusable casting mold, said method comprising:
performing the method of claim 15; and
for each of the plurality of sets of sacrificial inserts:
assembling a respective one of the plurality of sets of sacrificial inserts into the reusable outer shells to generate a respective mold;
pouring casting material into the internal cavity of the respective mold to cast a respective one of the multiple copies of the part such that a portion of the respective one of the plurality of sets of sacrificial inserts sacrificial inserts are sacrificed; and
excavating the respective one of the multiple copies of the part, including removing the reusable outer shells for reuse and remaining portions of the sacrificial inserts for disposal.

18. A computer-implemented method comprising:
receiving data for a part to be made by casting, said data received from a three dimensional scanning tool or at least one drawing file;
causing a binder jetting machine to generate reusable outer shells by printing and infiltrating the reusable outer shells with build material infiltrated with a relatively high strength material;
causing the binder jetting machine to generate a plurality of sets of sacrificial inserts with the build material, each configured for assembly, one set at a time, inside the reusable outer shells to define a respective internal cavity for a respective copy of the part to be casted and define a respective mold for casting said respective copy of the part.

19. A system for generating a partially reusable casting mold for creating multiple copies of a part by casting, said system comprising:
one or more non-transitory electronic storage devices comprising software instructions, which when executed, configure one or more processors to: perform the method of claim 18.

20. A system for creating multiple copies of a part by casting with a partially reusable mold, said system comprising:
a set of reusable outer shells comprising infiltrated build sand manufactured by binder jetting and infiltration with a high strength material; and
a plurality of sets of sacrificial inserts, each set being configured for assembly inside the set of reusable outer shells, one set at a time, to define a respective internal cavity for a respective copy of a part to be casted, wherein each of the plurality of sets of sacrificial inserts comprise non-infiltrated build sand manufactured by binder jetting, castings multiple copies of a part.
